(19) United States
(12) Patent Application Publication
(10) Pub. No.: US 2012/0198079 A1
(43) Pub. Date: Aug. 2, 2012

(54) PARALLEL TRANSMISSIONS OVER HTTP CONNECTIONS

(76) Inventor: Benjamin Spink, Flower Mound, TX (US)

(21) Appl. No.: 13/019,078

(22) Filed: Feb. 1, 2011

(51) Int. Cl. G06F 15/16

(52) U.S. Cl. 709/227; 709/230; 709/236; 709/233

(57) ABSTRACT

One example embodiment includes a system for transmitting data from a source system to a target system over an HTTP network. The system includes a user client, where the user client receives data to transmit from a source system to a target system. The system also includes a source tunnel. The source tunnel is configured to receive the data from the client and break the data into pieces for individual transmission. The source tunnel is also configured to establish a plurality of connections with a target system and transmit the pieces of the plurality on connections.

### CROSS-REFERENCE TO RELATED APPLICATIONS

Not applicable.

### BACKGROUND OF THE INVENTION

The Internet and other networking of computers has revolutionized the sharing of data. Today, data can be shared faster, and sent to more recipients, than at any time in history. As connection speeds and computer hardware continues to advance, file sizes get ever larger. This offers a number of new features to users, which in turn further increases the size of computer files. Further, users expect to be able to send these files almost instantaneously to virtually any person in the world.

However, the transmission of large amounts of data lags behind in many ways. In particular, completing a single transfer, of even moderately large files, can take a large amount of time. This results from a number of factors. One of the most significant factors in reducing transfer time is that network congestion and/or network latency can dramatically reduce the actual transmission speed of files.

There are a number of software applications that attempt to overcome these problems. For example, there are constant technological attempts to make the networks used for data transmission faster. That is, in the physical layer the transmission speed has continued to increase. Additionally, the interconnection of computers, both internally and externally, such as over the Internet, is becoming increasingly complex. This allows transmissions to route around areas of high congestion or latency.

There are other attempts to increase transmission speed as well. For example, the data can be broken into smaller packets, each of which is transmitted separately over different connection paths. This allows the transmission to occur over many paths, each of which may be configured to handle smaller amounts of data than the parent file. I.e., each packet may be able to take a path that would be unavailable to the parent file as a whole.

A drawback of many of these attempts is that they take place in the lower layers of the internet protocol suite. For example, many occur in the transport layer. Specifically, many use the transmission control protocol to divide and transmit the file. However, applications may use different transportation layer protocols, meaning that some applications are unable to take advantage of this transmission speed increase. Additionally, these workings are often “buried” meaning that applications may not have access to make changes dynamically, based on current network conditions.

Further, the lower the layer within the internet protocol suite, the more rigid the standards become. I.e., any application that accesses the transport layer expects certain things to occur within the transport layer. This leads to overall reliability, but allows for less change based on current network conditions. Similarly, the transportation layer must treat all data equally. Therefore, these programs lack the ability to change packet size, number of connections or many other factors, as needed.

Accordingly, there is a need in the art for a system that can adjust to current network conditions to produce the highest possible transmission speed. In particular, there is a need in the art for the system that can adjust transmitted file speed, number of connections or both. Additionally, there is a need for the system to reside in the application layer, where more flexibility is possible.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for transmitting data from a source system to a target system over an HTTP network. The system includes a user client, where the user client receives data to transmit from a source system to a target system. The system also includes a source tunnel. The source tunnel is configured to receive the data from the client and break the data into pieces for individual transmission. The source tunnel is also configured to establish a plurality of connections with a target system and transmit the pieces of the plurality on connections.

Another example embodiment includes a method of transmitting data from a source system to a target system over an HTTP network. The method includes breaking the data into two or more pieces, where each piece is assigned a number according to the order in which the data arrives. The method also includes establishing a plurality of HTTP network connections to transfer the pieces in parallel and transmitting the pieces in parallel. Transmitting the pieces in parallel includes transmitting the first piece over the first available HTTP network connection and transmitting the second piece over the next available HTTP network connection.

Another example embodiment includes a system embodied on a computer-readable storage medium bearing computer-executable instructions that, when executed by a logic device, carries out a method for transmitting data from a source system to a target system over a HTTP network. The system includes a logic device and one or more computer readable media, where the one or more computer readable media contain a set of computer-executable instructions to be executed by the logic device. The set of computer-executable instructions is configured to break the data into two or more pieces. Breaking the data into two or more pieces includes determining the preferred size of each piece and saving the piece as a distinct file to be transmitted. Breaking the data into two or more pieces also includes assigning an identification number to each piece. The set of computer-executable instructions is configured to transmit the pieces in parallel. Transmitting the pieces in parallel includes establishing one or more HTTP network connection and transmitting the two or more pieces over the HTTP network connection.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a block diagram of a system for allowing the transmission of data;

FIG. 2 illustrates a block diagram of a system for transmitting data from a source system to a target system over an HTTP network;

FIG. 3 is a flow chart illustrating an example of a method for transmitting data from a source system to a target system over an HTTP network;

FIG. 4 is a flow chart illustrating a method for dynamically adjusting the size of pieces to transmit over an HTTP network;

FIG. 5 is a flow chart illustrating a method of determining if additional HTTP connections should be completed; and

FIG. 6 illustrates an example of a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

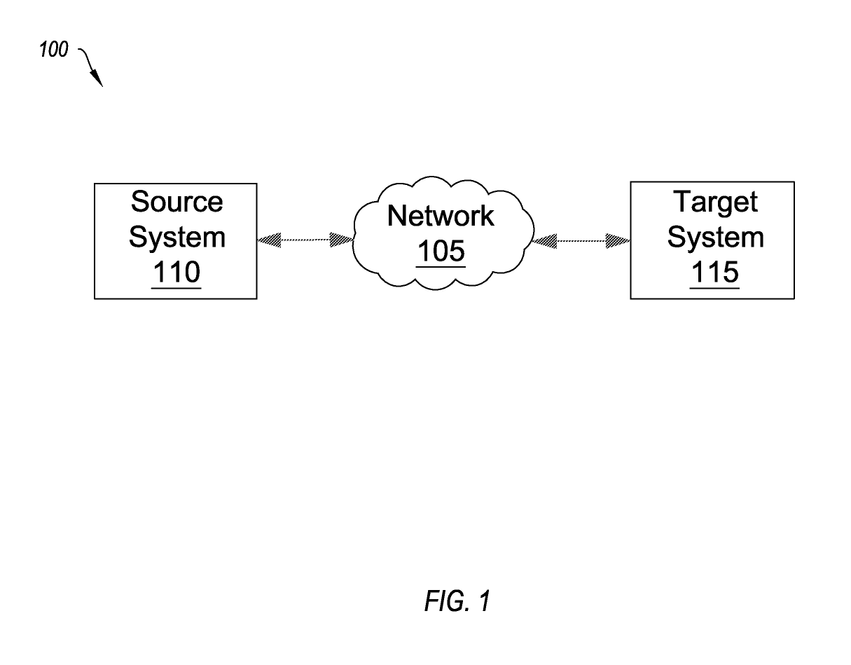

FIG. 1 illustrates a block diagram of a system 100 for allowing the transmission of data. In at least one implementation, the system 100 can establish a connection over which the data can be transmitted. The system 100 can allow for transmission of any file from a source to a target.

FIG. 1 shows that the system 100 can include a network 105. In at least one implementation, the network 105 can be used to connect the various parts of the system 100 to one another. The network 105 exemplarily includes the Internet, including a global internetwork formed by logical and physical connections between multiple wide area networks and/or local area networks and can optionally include the World Wide Web (“Web”), including a system of interlinked hypertext documents accessed via the Internet. Alternately or additionally, the network 105 includes one or more cellular RF networks and/or one or more wired and/or wireless networks such as, but not limited to, 802.xx networks, Bluetooth access points, wireless access points, IP-based networks, or the like. The network 105 can also include servers that enable one type of network to interface with another type of network.

In at least one implementation, the network 105 can include a Hypertext Transfer Protocol (HTTP) network. HTTP functions as a request-response protocol in the client-server computing model. In HTTP, a web browser, for example, acts as a client, while an application running on a computer hosting a web site, for example, functions as a server. The client submits an HTTP request message to the server. The server, which stores content, or provides resources, such as HTML files, or performs other functions on behalf of the client, returns a response message to the client. The response contains completion status information about the request and may contain any content requested by the client in its message body.

The HTTP protocol can be designed to permit intermediate network elements to improve or enable communications between clients and servers. For example, high-traffic websites can benefit from web cache servers that deliver content on behalf of the original, so-called origin server to improve response time. Additionally or alternatively, HTTP proxy servers at network boundaries facilitate communication when clients without a globally routable address are located in private networks by relaying the requests and responses between clients and servers.

HTTP is an Application Layer protocol designed within the framework of the Internet Protocol Suite. The protocol definitions presume a reliable Transport Layer protocol for host-to-host data transfer. The Transmission Control Protocol (TCP) is the dominant protocol in use for this purpose. However, HTTP has found application even with unreliable protocols, such as the User Datagram Protocol (UDP) in methods such as the Simple Service Discovery Protocol (SSDP).

HTTP Resources are identified and located on the network by Uniform Resource Identifiers (URIs)—or, more specifically, Uniform Resource Locators (URLs)—using the http or https URI schemes. URIs and the Hypertext Markup Language (HTML), form a system of inter-linked resources, called hypertext documents, on the Internet. HTTP can reuse a connection multiple times, to download, for instance, images for a just delivered page. Hence HTTP communications experience less latency as the establishment of TCP connections presents considerable overhead. One of skill in the art will appreciate that although an HTTP connection is treated as exemplary herein, the system 100 is capable of use with any application layer protocol.

FIG. 1 also shows that the system 100 can include a source system 110. In at least one implementation, the source system 110 can include any device that is capable of storing or producing data. In particular, the source system 110 can store or produce data to be transmitted over the network 105. For example, the source system 110 can include a server, a computer, a database, a mobile device or any other system capable of storing or producing data. The data can be stored in digital form, analog form or in any other form capable of transmission over the network 105. For example, the source system 110 can include memory or memory banks or processors which allow a user to input data for transmission.

FIG. 1 further shows that the system 100 can include a target system 115. In at least one implementation, the target system 115 can include any device that is capable of receiving data. In particular, the target system 110 can receive data that has been transmitted over the network 105. For example, the target system 115 can include a server, a computer, a database, a mobile device or any other system capable of storing or receiving data. The data can be received in digital form, analog form or in any other form capable of transmission over the network 105.

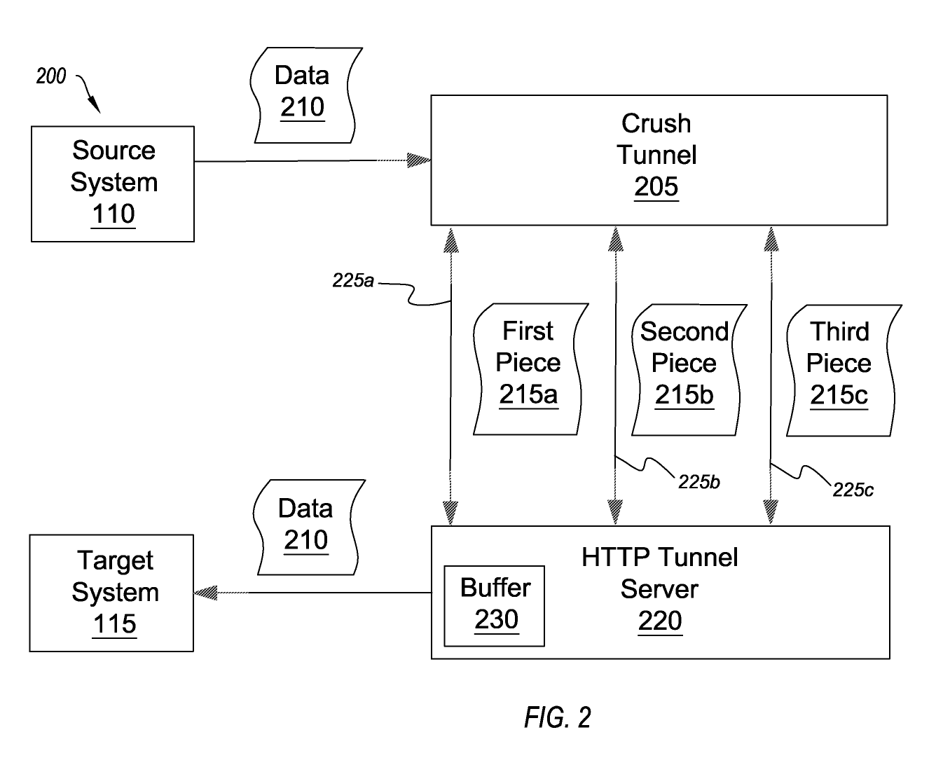

FIG. 2 illustrates a block diagram of a system 200 for transmitting data from a source system to a target system over a HTTP network. In at least one implementation, the system 200 intentionally remains in the application layer. This provides flexibility for the system 200 to dynamically adjust in order to increase the speed of the transfer, as described below. I.e., the application layer system 200 can use the lower layers of the Internet Protocol Suite to change the transmission parameters, as needed. One of skill in the art will appreciate that the parts of the system 200 can be implemented in hardware, software or a combination thereof unless otherwise specified.

FIG. 2 shows that the system 200 includes a source system 110. In at least one implementation, the source system 110 can include a client. A client is often referred to as a user agent (UA). Web clients range from Web browsers to search engine crawlers (spiders), as well as mobile phones, screen readers and braille browsers used by people with disabilities. When a client operates, it typically identifies itself, its application type, operating system, software vendor, or software revision, by submitting a characteristic identification string to its operating peer in a header field. The header field can also include a URL and/or e-mail address so that the Webmaster can contact the operator of the bot.

FIG. 2 also shows that the system 200 can include a source tunnel 205. In at least one implementation, the source tunnel 205 can maximize the speed of the transmission. In particular, the source tunnel 205 can adjust the size of data being transmitted, the number of HTTP connections, or any other variable based on available connections, network congestion, network latency or other factors in order to increase the transfer speed.

FIG. 2 shows that the source tunnel 205 can receive data 210 from the source system. In at least one implementation, the data 210 can include any data capable of being transmitted over an HTTP connection. For example, the data can include computer files, messages or any other data to be transmitted over a network. The source tunnel 205 can break the data 210 into multiple pieces. For example, FIG. 2 shows the data 210 broken into a first piece 215a, a second piece 215b and a third piece 215c (collectively “pieces 215”). One of skill in the art will appreciate that the number of pieces 215 can be dynamic, depending on a number of variables, as described below, and is not limited to three pieces 215. In particular, the number of pieces 215 and the size of each of the pieces 215 can vary as needed in order to provide the greatest speed, as described below. For example, smaller files can be transmitted without breaking the data 210 into pieces 215. In contrast, large files or slow connection speeds can result in multiple pieces 215.

One of skill in the art will appreciate that the source tunnel 205 is capable of receiving additional data and beginning the transmission of the additional data before the data 210 has completed its transmission. The transmission of the additional data can be accomplished over the same HTTP connections established by the source tunnel 205 or other connections. The data 210 can include information about the transmission priority that should be afforded the data 210 by the source tunnel 205.

FIG. 2 also shows that the system 200 can include an HTTP tunnel server 220. In at least one implementation, the HTTP tunnel server 220 receives the pieces 215 from the source tunnel 205. The HTTP tunnel server 220 can identify the proper order of the pieces 215 and assemble the pieces 215 back into the original data 210. Additionally or alternatively, the HTTP tunnel server 220 can forward the pieces 215, as described below. If one or more of the pieces 215 has not been received within a certain amount of time, the HTTP tunnel server 220 can request that the missing piece be resent. Additionally or alternatively, the HTTP tunnel server 220 can provide confirmation to the source tunnel 205 for each of the pieces 215 which is received. If confirmation is not received within a certain time frame, the source tunnel 205 can retransmit the lost piece.

FIG. 2 shows that the source tunnel 205 establishes a first connection 225a, a second connection 225b and a third connection 225c (collectively “connections 225”) with the HTTP tunnel server 220. One of skill in the art will appreciate that the number of connections 220 can be dynamic, depending on the circumstances, as described below, and is not limited to three connections 220 and is further not limited to the number of pieces 215 being sent over the connection 220. In at least one implementation, the number of connections 225, the speed of the connection 225 and the number of pieces 215 can influence each other, as described below.

FIG. 2 also shows that the HTTP Tunnel Server 220 can include a buffer 230. In at least one implementation, a buffer 230 is a region of memory used to temporarily hold data while it is being moved from one place to another. In particular, the buffer 230 can be used to store one of the pieces 215 if it is received out of order. For example, if the third piece 215c is received prior to the second piece 215b the third piece 215c can be stored in the buffer 230 until the second piece 215b has been received and forwarded. The buffer 230 can include any type of memory. For example, the buffer 230 can include RAM or hard drives.

FIG. 2 further shows that the HTTP Tunnel Server 220 forwards the reassembled data 210 to the target system 115. In at least one implementation, the data 210 can be assembled into a complete file before being forwarded to the target system 115. Additionally or alternatively, the pieces 215 can be forwarded to the target system 115 in the correct order.

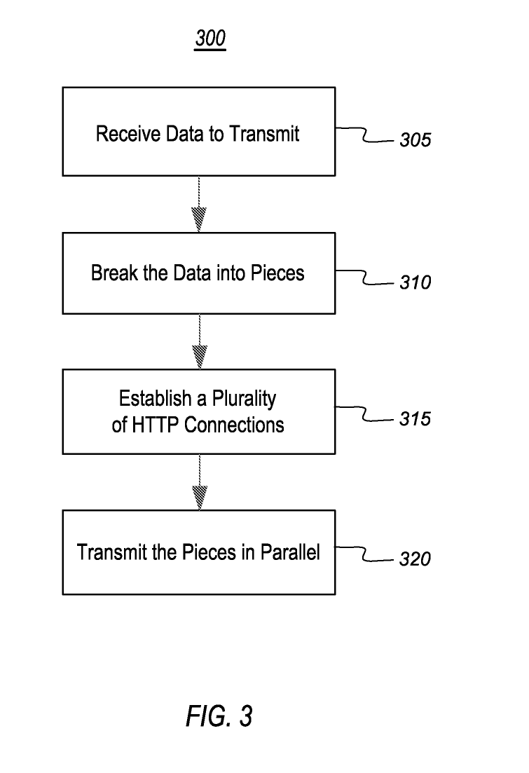

FIG. 3 is a flow chart illustrating an example of a method 300 for of transmitting data from a source system to a target system over a HTTP network. In at least one implementation, the method 300 can increase the speed of the transfer. In particular, the method 300 can adjust to network conditions and file size to adjust the transfer parameters in order to maximize the speed of the transfer. One of skill in the art will appreciate that the method 300 can be used with the system 100 of FIG. 1 or the system 200 of FIG. 2; however, the method 300 can be used with a system other than the system 100 of FIG. 1 or the system 200 of FIG. 2.

FIG. 3 shows that the method 300 includes receiving the data to transmit 305. In at least one implementation, the data can be received from a user. In particular, a user can prepare a message or data transfer from the source system to the target system. One of skill in the art will appreciate that the user can make the request from either the source system or the target system. Additionally or alternatively, the data transfer can occur from computer to computer without user interaction. For example, the data transfer can occur on a scheduled basis or include other automatic transfers.

FIG. 3 also shows that the method 300 can include breaking the data into pieces 310. In at least one implementation, the data can be broken into regular sizes. For example, the data can be separated into pieces that are consistent in size. Additionally or alternatively, the size of the data pieces can vary according to other factors including, network speed, overall file size, network congestion, network latency, network reliability and other factors, as described below.

In at least one implementation, breaking the data into pieces 310 can include identifying the order of the pieces. In particular, each piece can be assigned a sequence number which indicates the order of the pieces within the data. For example, the pieces can be given sequential integer values. Additionally or alternatively, other information can be provided to identify the order.

FIG. 3 further shows that the method 300 can include establishing a plurality of HTTP connections 315. In at least one implementation, establishing a plurality of HTTP connections can prove more efficient or more convenient than lower level connections such as TCP/IP connections. In particular, although the data overhead may increase slightly by establishing an HTTP connection, the flexibility in finding connections and varying the size of the pieces being sent can make up for the speed loss due to extra overhead.

FIG. 3 also shows that the method 300 can include transmitting the pieces in parallel 320. In at least one implementation, transmitting the pieces in parallel 320 can include transmitting the pieces simultaneously over different HTTP connections. Additionally or alternatively, one or more pieces may be transmitted over a single HTTP connection. For example, if the first piece is transmitted over a first HTTP connection, a subsequent piece can be transmitted over the first HTTP connection after the first piece has been sent.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

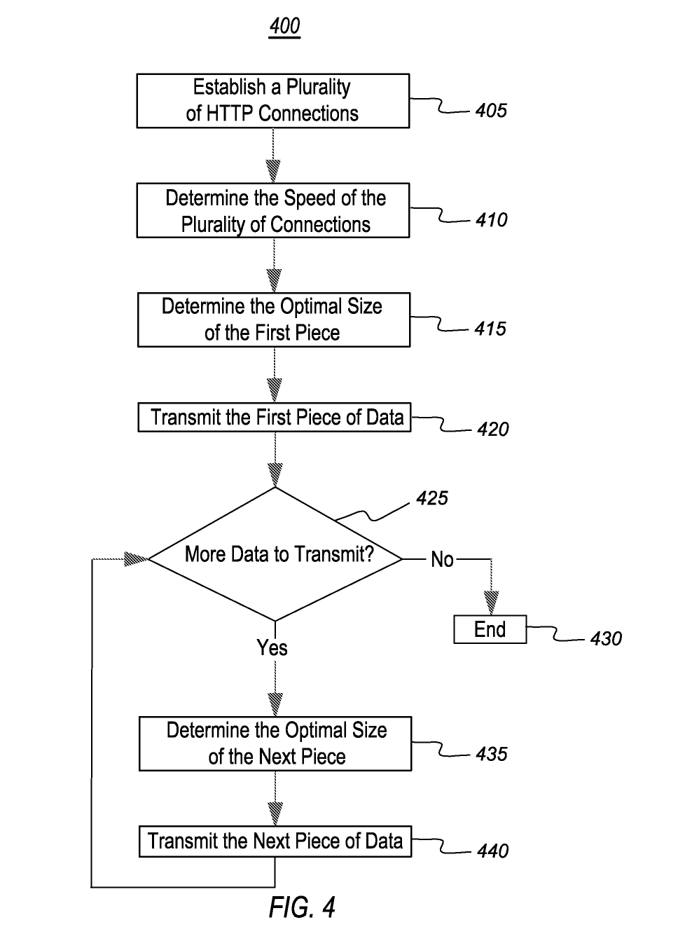

FIG. 4 is a flow chart illustrating a method 400 for of dynamically adjusting the size of pieces to transmit over an HTTP network. In at least one implementation, the method 400 can increase the speed of the transfer. In particular, the method 400 can adjust to network conditions and file size to adjust the transfer parameters in order to maximize the speed of the transfer. One of skill in the art will appreciate that the method 400 can be used with the system 100 of FIG. 1 or the system 200 of FIG. 2; however, the method 400 can be used with a system other than the system 100 of FIG. 1 or the system 200 of FIG. 2.

FIG. 4 shows that the method 400 includes establishing a plurality of HTTP connections 405. In at least one implementation, the plurality of HTTP connections can be established over a single network. For example, the plurality of HTTP connections can be established over an Intranet or over the Internet. Additionally or alternatively, the plurality of connections can be established over multiple networks or multiple network connections. In at least one implementation, establishing a plurality of HTTP connections can prove more efficient or more convenient than lower level connections such as TCP/IP connections. In particular, although the data overhead may increase slightly by establishing an HTTP connection, the flexibility in finding connections and varying the size of the pieces being sent can make up for the extra overhead.

FIG. 4 also shows that the method 400 can include determining the speed of the plurality of connections 410. In at least one implementation, the speed can be determined by pinging the connection. In particular, pinging the connection can include sending echo request packets to the target server and waiting for a response. The process can measure the time from transmission to reception (round-trip time) and records any packet loss. One of skill in the art will appreciate that determining the speed of the plurality of connections 410 can be done when the connections are first established, before any data is sent or at any other time.

FIG. 4 further shows that the method 400 can include determining the optimal size of the first piece 415. The optimal size of the first piece can be based on a combination of the overall file size, the number of connections, the loss rate of the connections, the speed of the connections and any other factor. For example, if the connection speed is low, the optimal size of the first piece may be smaller in order to allow more data to be transmitted on connections with higher transmission speeds. In contrast, if the number of connections is low, the optimal size of the first piece may be larger in order to reduce the overhead associated with transmitting the first piece of data.

FIG. 4 also shows that the method 400 can include transmitting the first piece of data 420. In at least one implementation, the first piece of data can be transmitted to the target system over a first HTTP connection. The other connections already established or to be established later can be used for transmitting other pieces, as described below.

FIG. 4 shows that the method 400 can include determining if there is more data to transmit 425. In at least one implementation, determining if there is additional data to transmit 425 can include determining how much of the original file remains to be transmitted. Additionally or alternatively, determining if there is additional data to transmit 425 can include determining if additional data has been submitted for transmission.

FIG. 4 shows that the method 400 can include ending 430 the transmission if there is no more data to transmit. In contrast, the method 400 can include determining the optimal size of the next piece 435 if there is more data to transmit. The optimal size of the next piece can be based on a combination of the overall file size, the number of connections, the loss rate of the connections, the speed of the connections and any other factor. For example, if the connection speed is low, the optimal size of the next piece may be smaller in order to allow more data to be transmitted on connections with higher transmission speeds. In contrast, if the number of connections is low, the optimal size of the next piece may be larger in order to reduce the overhead associated with transmitting the next piece of data.

FIG. 4 also shows that the method 400 can include transmitting the next piece of data 440. In at least one implementation, the next piece of data can be transmitted to the target system over a connection that is parallel to the first connection. Additionally or alternatively, the next piece of data can be transmitted to the target system over the first connection, if the first connection is done transmitting the first piece. The other connections already established or to be established later can be used for transmitting other pieces, as described below.

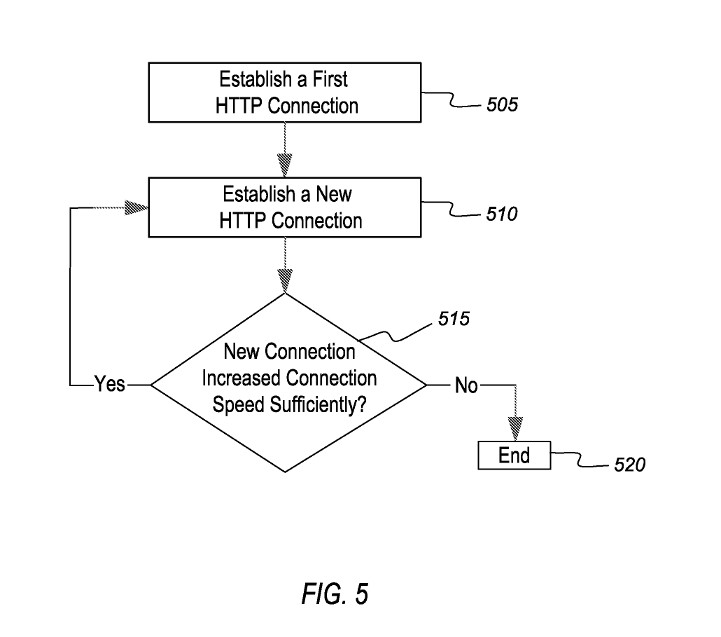

FIG. 5 is a flow chart illustrating a method 500 of determining if additional HTTP connections should be completed. In particular, the method 500 can be used to determine if the addition of an HTTP connection will increase the transfer speed of the data begin transferred. One of skill in the art will appreciate that the method 500 can allow the number of connections to change as needed as network conditions change.

FIG. 5 shows that the method 500 includes establishing a first HTTP connection 505. In at least one implementation, establishing the first HTTP connection 505 can include determining the speed of the first HTTP connection. In particular, determining the speed of the first HTTP connection can include pinging the connection or otherwise measuring the speed of the first HTTP connection.

FIG. 5 also shows that the method 500 can include establishing a new HTTP connection 510. In at least one implementation, the new HTTP connection can be established over the same network as the first HTTP connection. Additionally or alternatively, the new HTTP connection can be established over an alternative network. One of skill in the art will appreciate that although some portion of the first HTTP connection and the new HTTP connection may be shared, some portion will be different.

FIG. 5 further shows that the method 500 can include determining if the new connection increased transmission speed sufficiently 515. In at least one implementation, the increase in transmission speed can be considered “sufficient” if the increase in speed is above a certain threshold. In particular, if the addition of the new connection increases the connection speed a certain percentage, the increase in speed can be considered sufficient. In at least one implementation, the threshold can be that the new connection increase the total connection speed more than 48%. For example, the threshold can be that the new connection increase the total connection speed more than 60%.

FIG. 5 also shows that the method 500 includes ending 520 if the speed increase is not deemed sufficient. In contrast, if the speed increase was sufficient, the method 500 includes adding a new HTTP connection 510. One of skill in the art will appreciate that the number of connections can be dynamic over a period of time as connection speeds change.

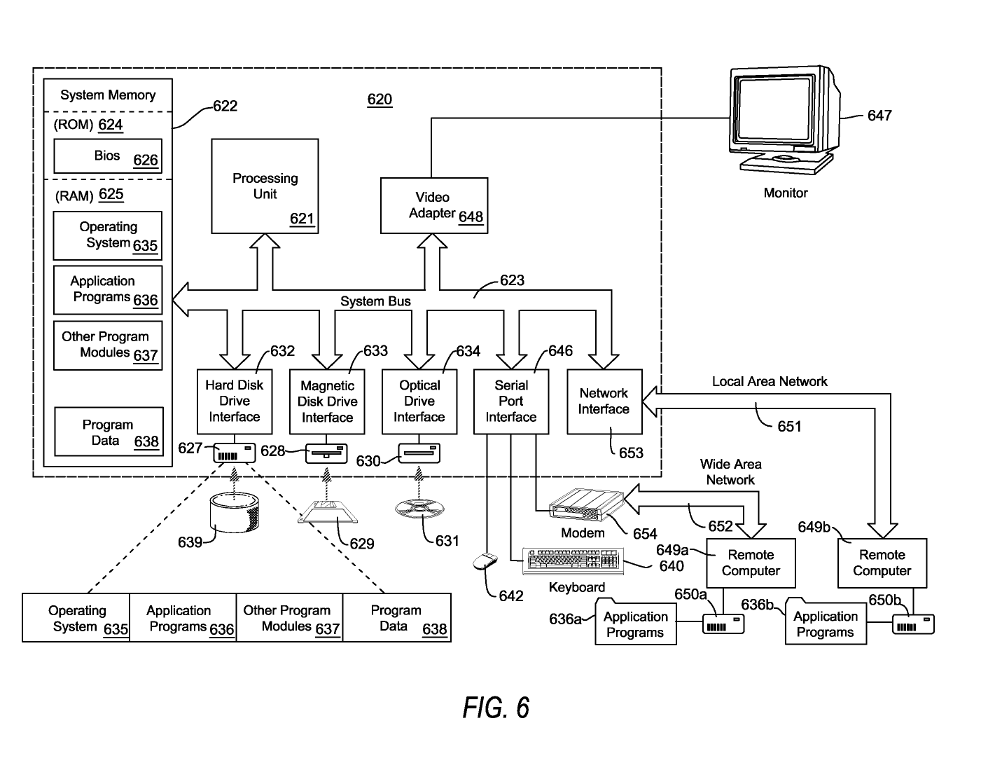

FIG. 6, and the following discussion, is intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One skilled in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 6, an example system for implementing the invention includes a general purpose computing device in the form of a conventional computer 620, including a processing unit 621, a system memory 622, and a system bus 623 that couples various system components including the system memory 622 to the processing unit 621. It should be noted however, that as mobile phones become more sophisticated, mobile phones are beginning to incorporate many of the components illustrated for conventional computer 620. Accordingly, with relatively minor adjustments, mostly with respect to input/output devices, the description of conventional computer 620 applies equally to mobile phones. The system bus 623 may be any of several types of bus structures including a memory bus or memory controller, a peripheral bus, and a local bus using any of a variety of bus architectures. The system memory includes read only memory (ROM) 624 and random access memory (RAM) 625. A basic input/output system (BIOS) 626, containing the basic routines that help transfer information between elements within the computer 620, such as during start-up, may be stored in ROM 624.

The computer 620 may also include a magnetic hard disk drive 627 for reading from and writing to a magnetic hard disk 639, a magnetic disk drive 628 for reading from or writing to a removable magnetic disk 629, and an optical disc drive 630 for reading from or writing to removable optical disc 631 such as a CD-ROM or other optical media. The magnetic hard disk drive 627, magnetic disk drive 628, and optical disc drive 630 are connected to the system bus 623 by a hard disk drive interface 632, a magnetic disk drive-interface 633, and an optical drive interface 634, respectively. The drives and their associated computer-readable media provide nonvolatile storage of computer-executable instructions, data structures, program modules and other data for the computer 620. Although the exemplary environment described herein employs a magnetic hard disk 639, a removable magnetic disk 629 and a removable optical disc 631, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 639, magnetic disk 629, optical disc 631, ROM 624 or RAM 625, including an operating system 635, one or more application programs 636, other program modules 637, and program data 638. A user may enter commands and information into the computer 620 through keyboard 640, pointing device 642, or other input devices (not shown), such as a microphone, joy stick, game pad, satellite dish, scanner, or the like. These and other input devices are often connected to the processing unit 621 through a serial port interface 646 coupled to system bus 623. Alternatively, the input devices may be connected by other interfaces, such as a parallel port, a game port or a universal serial bus (USB). A monitor 647 or another display device is also connected to system bus 623 via an interface, such as video adapter 648. In addition to the monitor, personal computers typically include other peripheral output devices (not shown), such as speakers and printers.

The computer 620 may operate in a networked environment using logical connections to one or more remote computers, such as remote computers 649a and 649b. Remote computers 649a and 649b may each be another personal computer, a server, a router, a network PC, a peer device or other common network node, and typically include many or all of the elements described above relative to the computer 620, although only memory storage devices 650a and 650b and their associated application programs 636a and 636b have been illustrated in FIG. 6. The logical connections depicted in FIG. 6 include a local area network (LAN) 651 and a wide area network (WAN) 652 that are presented here by way of example and not limitation. Such networking environments are commonplace in office-wide or enterprise-wide computer networks, intranets and the Internet.

When used in a LAN networking environment, the computer 620 can be connected to the local network 651 through a network interface or adapter 653. When used in a WAN networking environment, the computer 620 may include a modem 654, a wireless link, or other means for establishing communications over the wide area network 652, such as the Internet. The modem 654, which may be internal or external, is connected to the system bus 623 via the serial port interface 646. In a networked environment, program modules depicted relative to the computer 620, or portions thereof, may be stored in the remote memory storage device. It will be appreciated that the network connections shown are exemplary and other means of establishing communications over wide area network 652 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for transmitting data from a source system to a target system over an HTTP network, the system comprising:
a user client, wherein the user client receives data to transmit from a source system to a target system;
a source tunnel, wherein the source tunnel is configured to:
receive the data from the client;
break the data into pieces for individual transmission;
establish a plurality of connections with a target system; and
transmit the pieces on the plurality of connections.

2. The system of claim 1, wherein the source tunnel assigns an index number to each piece.

3. The system of claim 1, wherein the client is a FTP client

4. The system of claim 1, wherein the client is a web browser.

5. The system of claim 1, further comprising:
an HTTP tunnel server, wherein the HTTP tunnel server is configured to receive the data from the source tunnel.

6. The system of claim 5, wherein the HTTP tunnel is further configured to assemble the pieces in the proper order.

7. The system of claim 5, wherein the HTTP tunnel is further configured to forward the pieces to a true destination port of the target system in the proper order.

8. The system of claim 5, wherein the HTTP tunnel server includes a buffer.

9. The system of claim 8, wherein HTTP tunnel server is configured to store a piece received out of order in the buffer until the piece can be added to the reassembled data.

10. The system of claim 1, wherein the number of HTTP connections varies dynamically according to:
the amount of data to transmit; and
the speed of the connections.

11. The system of claim 1, wherein the source tunnel continues to increase the number of connections until the maximum transmission speed is attained.

12. A method of transmitting data from a source system to a target system over an HTTP network, the method comprising:
breaking the data into two or more pieces, wherein each piece is assigned a number according to the order in which the data arrives;
establishing a plurality of HTTP network connections to transfer the pieces in parallel; and
transmitting the pieces in parallel, wherein transmitting the pieces in parallel includes:
transmitting the first piece over the first available HTTP network connection; and
transmitting the second piece over the next available HTTP network connection.

13. The system of claim 12, further comprising assigning an index number to the two or more pieces.

14. The system of claim 13, wherein the index numbers include sequential integers.

15. The system of claim 12, wherein the size of the first piece is the same size as the second piece.

16. The system of claim 12, wherein the size of the first piece is different than the size of the second piece.

17. A system embodied on a computer-readable storage medium bearing computer-executable instructions that, when executed by a logic device, carries out a method for transmitting data from a source system to a target system over a HTTP network, the system comprising:
a logic device;
one or more computer readable media, wherein the one or more computer readable media contain a set of computer-executable instructions to be executed by the logic device, the set of computer-executable instructions configured to:
break the data into two or more pieces, wherein breaking the data into two or more pieces includes:
determining the preferred size of each piece;
saving the piece as a distinct file to be transmitted; and
assigning an identification number to each piece;
transmit the pieces in parallel, wherein transmitting the pieces in parallel includes:
establishing one or more HTTP network connection; and
transmitting the two or more pieces over the HTTP network connection.

18. The system of claim 17, wherein the logic device includes a processor.

19. The system of claim 17, wherein establishing one or more HTTP network connections includes an HTTP network connection established over an Intranet.

20. The system of claim 17, wherein establishing one or more HTTP network connections includes an HTTP network connection established over the Internet.
